(19) United States
(12) Patent Application Publication
(10) Pub. No.: US 2012/0284591 A1
(43) Pub. Date: Nov. 8, 2012

(54) SYSTEMS AND METHOD FOR ELECTRONIC SIGNATURE DOCUMENT IDENTIFICATION AND CERTIFICATION

(75) Inventors: Jason Campbell Seed, Woodside, CA (US); Patrick Dewar Collins, Piedmont, CA (US)

(73) Assignee: VSIG.COM, INC., Redwood City, CA (US)

(21) Appl. No.: 13/403,912

(22) Filed: Feb. 23, 2012

Related U.S. Application Data
(60) Provisional application No. 61/482,993, filed on May 5, 2011.

(51) Int. Cl. G06F 17/00

(52) U.S. Cl. 715/201

(57) ABSTRACT

Systems and methods for electronic document electronic document identification and signing are provided. Certain embodiments of the present invention provide for a virtual signature tool to create a unique, verifiable, electronic signature (SigCode) for signing documents using a mobile device of an individual. In some embodiments, document identifiers (e.g., QR codes) can be used to identify and retrieve documents for digital signing. For example, upon scanning other document identifier, an electronic version of the document (e.g., a waiver) can be retrieved from a server. The electronic document can be displayed on the user's mobile device (e.g., through a webpage). Then, the user can review the electronic document, fill in any required information, and sign the document with an electronic signature generated by the electronic signature tool.

### CROSS REFERENCE TO RELATED APPLICATIONS

This application claims the benefit of U.S. Patent Application No. 61/482,993, which was filed on May 5, 2011, titled “Systems and Methods for Electronic Signature Software Certification,” the entire contents of which is hereby incorporated herein by reference for all purposes.

### TECHNICAL FIELD

Various embodiments of the present invention generally relate to systems and methods for electronic document identification, retrieval, and certification. In particular, embodiments of the present invention relate to systems and methods for electronically retrieving a stored document and providing a user with a virtual signature tool to create a unique, verifiable, electronic signature for signing documents.

### BACKGROUND

With the proliferation of electronic communications, documents can be transmitted electronically. Traditionally, in order to sign a document, the document had to be printed, signed, and then delivered to an intended recipient. However, an individual may not be near a printer to print the document. Even if a printer is nearby, the individual would then have to spend time scanning, faxing, mailing, or otherwise transmitting the document to the intended recipient. In many cases, only the signature page of the document is returned to the recipient. This process can be slow, inconvenient, insecure, and time consuming.

More recently, electronic signatures have been used to sign documents. These electronic signatures, for example, can include a scanned copy of the individual's signature, a typed signature, and/or a signature generated by mouse gestures. While the use of electronic signature can eliminate the need to print the document. These techniques are insecure and not verifiable. In addition, the document may need to be completed by the individual before signing. Completing the document by typing information about the individual can be repetitive and take time. In addition, the individual may miss one or more areas within the document that need to be completed. As such, there are a number of challenges and inefficiencies found in traditional ways of signing documents.

### SUMMARY

Systems and methods are described for electronic document identification and certification. In some embodiments, a method for signing a document can include receiving, at a mobile device, an electronic version of a document to be signed by a recipient. The electronic version of the document can be delivered to the mobile device in response to the recipient scanning a document identifier (e.g., a quick response code) with the mobile device, retrieved from a website, or sent from a requestor asking the recipient to sign the document. Upon reviewing the electronic document, an electronic signature can be generated from the mobile device. In some embodiments, the electronic signature includes identifying information about the recipient and/or the document (e.g., geographic location information, mobile carrier information, mobile device identifiers, a document version number, or others). Once the signature has been generated, a receipt can be created to provide verification that the document has been signed.

In some embodiments, a first user interface screen can be displayed on a mobile device in response to a request to retrieve an electronic document. The first user interface screen can display the electronic document and provide an interface for receiving a population request from a user to populate one or more user-specific fields within the electronic document. In response to the population request, a second user interface screen can be displayed on the mobile device. The second user interface screen can include a population tool listing the one or more user-specific fields (e.g., name, address, telephone number, title, etc) within the document to be populated. These fields can be automatically populated from a user profile or manually entered by the user.

Once the user-specific fields have been supplied through the population tool, a third user interface screen can be displayed on the mobile device. In some embodiments, the third user interface screen presents the electronic document with the populated fields along with a signing widget capable generating an electronic signature for the electronic document with the populated fields. In some embodiments, in response to the signing widget generating the electronic signature, a receipt can be generated to verify signing of the electronic document. This receipt can be transmitted to a specified destination (e.g., owner of the document, recordation service, etc) and/or displayed within a fourth user interface screen on the mobile device.

Various embodiments of the present invention also include computer-readable storage media containing sets of instructions to cause one or more processors to perform the methods, variations of the methods, and other operations described herein.

The systems provided by various embodiments can include a document database, a member database, a certification system, an interface portal, a field module, a population module, a signature module, a communications module, and/or a receipt module. The document database can be used to store electronic versions of documents to be delivered to various users of the signature system. The member database can be used to store profiles of the document owners and/or end-users. In some embodiments, a request to retrieve an electronic document (e.g., having user-specific fields) using a document identifier can be received through an interface portal. The field module can receive information indicative of the user-specific fields, if any, within the electronic document and generate a graphical interface allowing a user to assign values to the user-specific fields. The population module receives the values assigned to the user-specific fields and populates the electronic document with the values. The signature module can then be used to generate an electronic signature (SigCode) for signing the electronic document.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present invention will be described and explained through the use of the accompanying drawings in which:

FIG. 1 is an example of an operating environment in which some embodiments of the present invention may be utilized;

FIG. 2 is a block diagram illustrating exemplary components of an electronic signature system according to one or more embodiments of the present invention;

FIG. 3 is a flow chart illustrating an exemplary process for obtaining electronic signatures from multiple recipients in accordance with some embodiments of the present invention;

FIG. 4 is a flow chart illustrating an exemplary process for electronically signing a document in accordance with various embodiments of the present invention;

FIG. 5 shows a document with a document identifier for electronically identifying and retrieving an electronic version of the document in accordance with one or more embodiments of the present invention;

FIG. 6 shows an illustration of a mobile device displaying an electronic version of a document having one or more user-specific fields in accordance with various embodiments of the present invention;

FIG. 7 illustrates a mobile device with a population tool for populating user-specific fields within an electronic document in accordance with some embodiments of the present invention;

FIG. 8 illustrates a mobile device displaying an electronic version of a document having one or more user specific fields populated in accordance with one or more embodiments of the present invention;

FIG. 9 shows an illustration of a mobile device displaying an electronic signature in accordance with various embodiments of the present invention;

FIG. 10 shows an illustration of a mobile device displaying signing receipt in accordance with various embodiments of the present invention; and

FIG. 11 illustrates an example of a computer system with which some embodiments of the present invention may be utilized.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Various embodiments of the present invention generally relate to electronic document identification and signing systems. Certain embodiments of the present invention provide for a virtual signature tool to create a unique, verifiable, electronic signature for signing documents. In accordance with various embodiments, the virtual signature tool can use a smart phone or other mobile device to create the unique, verifiable, electronic signature (SigCode). For example, the electronic or virtual signature tool can create a quick response (QR) code to capture user information to form a unique, verifiable, electronic signature for signing documents.

In some embodiments, document identifiers (e.g., QR codes) can be used to identify and retrieve documents for digital signing. For example, a user can receive a non-electronic version of a document (e.g., such as a waiver form from a school) to be signed. The document can include a QR code or other document identifier which can be scanned by the user to retrieve an electronic version of the document from a server. The electronic document can be displayed on the user's mobile device (e.g., through a webpage). Then, the user can review the electronic document, fill in any required information, and sign the document with an electronic signature generated by the electronic signature tool.

In other embodiments, the user can receive a request to sign a document. The request can include the document or a link to access a secured server which is storing the document. Using the electronic signature tool (e.g., on a smart phone or other mobile device) the user can review the electronic document and sign the document with an electronic signature generated by the tool. The tool creates a unique signature (SigCode) using various information about the user such as, but not limited to, phone identification information, carrier identification, network address, time, date, geographic location (e.g., provided by a GPS within the mobile device), user provided information, information about the document to be signed, etc.

The e-signing process, in some embodiments, begins by e-mailing a document or notification to one or more e-mail addresses provided by the signing service that are associated with one or more users. A server communicates directly with the smart phone(s) associated with the one or more e-mail address at which point the users can be prompted that they have a document to sign. Each user can then independently review and sign the document. This can be particularly useful, for example, when the recipients are in different locations or there are a large number of signatures needed (e.g., during proposition and/or ballot initiatives). In accordance with various embodiments, the master document may be stored on the server, and only a copy e-mailed to the one or more users, or a link or other mechanism may be provided to the user to facilitate review and e-signing.

In some cases, the user may have created multiple profiles for signing a document. Example profiles include a personal profile, a parent profile, a representative of a first company, another profile for a second job, etc. Each profile could contain different contact information (e.g., phone numbers, e-mail address, etc.), different titles, different signatures, and the like. If multiple profiles are available, the user can select which profile should be used in creating the electronic signature.

Once a profile is selected, a user may be prompted for an additional verification code (e.g., a PIN or other code) which may have been set by the user or by the creator of the document. For example, for extra security, the creator of the document may generate a unique code, or request that a unique code be generated, for each user and/or document. This unique code could be delivered separately from the document. In some embodiments, for example, the code could be delivered by postal mail, to a secondary e-mail address on file, via an automated voice call to the user, via text message, or any other means.

Once the verification code has been authenticated, the electronic signature can be created which captures a variety of identifying information such as, but not limited to, phone identification information, time, date, gps location, user provided information, verification codes, information about the document to be signed, date and time the document was sent to the user, who sent the document, version of the document, etc. All required signature pages within the document can be identified and all fields can be populated with information about the signer. The signed document can then be returned to the owner.

In some embodiments, the SigCode (e.g., the QR code) associated with the user can be placed onto every single page of the document (e.g., contract, agreement, petition, etc). The signature page can be filled with a full long form version of the electronic signature that may include the signer's photo, an image of their digital signature or a cursive representation of their name, and the QR code (which may also be a dynamic link to the profile of the signer if being viewed online). One advantage of attaching the SigCode to every page is the visual confirmation provided in a printed document that all the original pages are the ones that were present on signing.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

The techniques introduced here can be embodied as special-purpose hardware (e.g., circuitry), or as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

Moreover, embodiments of the present invention may also be downloaded as a computer program product or data to be used by a computer program product, wherein the program, data, and/or instructions may be transferred from a remote computer or mobile device to a requesting computer or mobile device by way of data signals embodied in a carrier wave or other propagation medium via a communication link (e.g., a modem or network connection). In some cases, parts of the program, data, or instructions may be provided by external networks such as the telephony network (e.g., Public Switched Telephony Network, cellular, Wi-Fi, and other voice, data, and wireless networks) or the Internet. The communications link may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks.

For convenience, embodiments of the present invention are described with reference to electronic signature and certification tools that may be used on a mobile device, a smart phone, or other computing platform. Various embodiments are applicable to other operational models and applications, including different types of computing platforms, signature types, security measures, and signing operations. For example, while some embodiments create a QR code as part of the electronic signature, other types of signatures may be created in other embodiments. In addition, various embodiments may provide different features for different service tiers (e.g., free-user vs. a fee based subscription). In some embodiments, the application may be linked to, or used within, a social media community or platform. In addition, the features of many embodiments may be accessed by users using a software package or hardware device (with associated software or firmware) which may be directly installed on or connected to an end user's computer or mobile device. In some cases, access to the software and/or hardware device may be provided through various communication connections such as the Internet.

### Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to various embodiments,” “in the embodiments shown,” “in one embodiment,” “in other embodiments,” and the like generally mean the particular feature, structure, or characteristic following the phrase is included in at least one embodiment of the present invention, and may be included in more than one embodiment of the present invention. In addition, such phrases do not necessarily refer to the same embodiments or to different embodiments.

If the specification states a component or feature “may”, “can”, “could”, or “might” be included or have a characteristic, that particular component or feature is not required to be included or have the characteristic.

The term “responsive,” “in response,” and other variants include completely and partially responsive.

The term “module” refers broadly to software, hardware, or firmware (or any combination thereof) components. Modules are typically functional components that can generate useful data or other output using specified input(s). A module may or may not be self-contained. An application program (also called an “application”) may include one or more modules, or a module can include one or more application programs.

### General Description

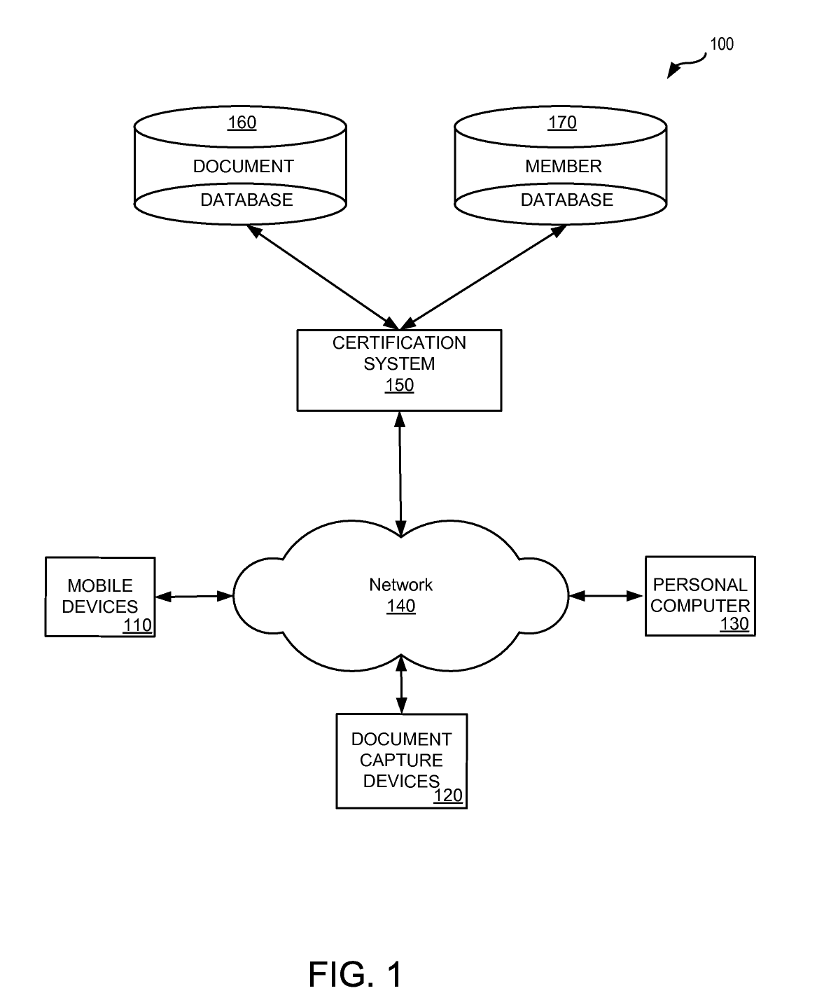

FIG. 1 illustrates an example of an operating environment 100 in which some embodiments of the present invention may be utilized. Various embodiments of the present invention illustrated in FIG. 1 allow an owner of a document to request signatures from one or more recipients through various points of interaction such as, but not limited to, mobile devices 110 (e.g., mobile phone), image capture devices 120, personal computers 130, and/or other devices. In other embodiments, an end-user can request a document (e.g., a waiver or other form) to sign.

The owner of the document can submit the document through network 140 to certification system 150 for signing by one or more recipients. For example, in some embodiments, the owner may specify a specific set of recipients. In other embodiments, the user may allow the document to be delivered and signed upon request from any person desiring to sign the document. The document may be submitted to the certification system by e-mailing the document to an e-mail address associated with certification system 150. The e-mail address can be affiliated with one or more desired recipients. Certification system 150, can then distribute the document to the recipients for signing.

In some embodiments, certification system 150 distributes the document, or a notification or link that can be used to access the document from a secured server, to a mobile device 110 associated with the recipient. Mobile device 110 may be a cellular phone, a smart phone (a smart phone being a cellular phone that has capabilities and features such as, but not limited to, internet access, GPS, a full keyboard, email access, Wi-Fi connection capabilities, and/or any other functionality of a computer), or another mobile device. Once the document is received, each recipient can review the document and generate a SigCode which can then be submitted to certification system 150.

Certification system 150 may include a combination of system components, modules, and/or devices for recording the signature, verifying authenticity of the signature, delivering the document, storing user information, storing the documents, etc. In addition, some embodiments provide for a signature tool which may be installed directly on the recipient's mobile device for generating the electronic signatures (SigCode).

As illustrated in FIG. 1, certification system 150 can be communicably coupled to one or more databases such as document database 160 and member database 170. These databases can have a variety of information that can be utilized by the certification system 150. For example, document database 160 can store information about the documents (e.g., user specific-fields) as well as copies of the documents. Member database 170 can store information about users (or customers) of certification system 150. For example, membership database 170 can store information such as user profiles, contact information, service tiers, which documents the user has signed, which documents the user has submitted for signature, and the like.

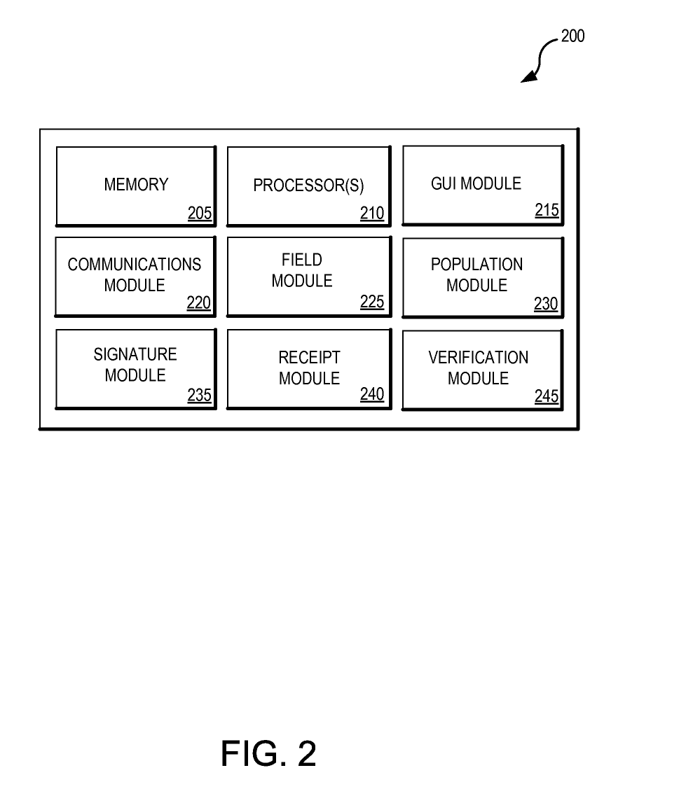

FIG. 2 shows a block diagram illustrating exemplary components of an electronic signature system according to one or more embodiments of the present invention. According to the embodiments shown in FIG. 2, the electronic signature system can include memory 205, one or more processors 210, GUI generation module 215, communications module 220, field module 225, population module 230, signature module 235, receipt module 240, and verification module 245. Other embodiments of the present invention may include some, all, or none of these modules and components along with other modules, engines, interfaces, applications, and/or components. Still yet, some embodiments may incorporate two or more of these elements into a single module and/or associate a portion of the functionality of one or more of these elements with a different element. For example, in one embodiment, field module 225 can be combined with population module 230.

Memory 205 can be any device, mechanism, or populated data structure used for storing information. In accordance with some embodiments of the present invention, memory 205 can encompass any type of, but is not limited to, volatile memory, nonvolatile memory and dynamic memory. For example, memory 205 can be random access memory, memory storage devices, optical memory devices, media magnetic media, floppy disks, magnetic tapes, hard drives, SIMMs, SDRAM, DIMMs, RDRAM, DDR RAM, SODIMMS, erasable programmable read-only memories (EPROMs), electrically erasable programmable read-only memories (EEPROMs), compact disks, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 205.

Memory 205 may be used to store instructions for running one or more modules, engines, interfaces, and/or applications on processor(s) 210. For example, memory 205 could be used in one or more embodiments to house all or some of the instructions needed to execute the functionality of GUI generation module 215, communications module 220, field module 225, population module 230, signature module 235, receipt module 240, and/or verification module 245.

GUI generation module 215 can be used in some embodiments to generate one or more graphical user interface screens configured to receive instructions, receive documents for use with the certification system, receive profile selections, receive user information, and/or verify signature properties. These GUI screens can be displayed on the mobiles devices 110, document capture devices 120, personal computers 130, and/or other terminal devices.

Communications module 220, in accordance with one or more embodiments of the present invention, manages and translates any requests from a user (e.g., received through a graphical interface screen), application, or tool into a format required by the destination component, tool, and/or system. Similarly, communications module 220 may be used for communications between modules, databases, and/or systems that use different communication protocols, data formats, and/or messaging routines. In some cases, communications module 220 can be used for communicating profile information or data associated with a document.

Field module 225 can be used to receive information indicative of the user-specific fields within the electronic document. This information can be used to generate a graphical interface allowing a user to assign values to the user-specific fields. In some embodiments, population module 230 generates a population tool with the user-specific fields that allows the user to assign values to the fields. In some cases, these fields may be automatically populated using a user profile. Once the values have been assigned, population module 230 populates the electronic document with the values.

Signature module 235 can be used to generate an electronic signature for signing the electronic document. In some embodiments, the electronic document includes a list of information (e.g., gps-generated location, time stamp, mobile device identification, photo of the signer, etc) required for signing the document. This information can be specified by the owner of the document upon submission to the certification system. In some embodiments, signature module 235 can be used to gather user information and generate a unique, verifiable, electronic signature (SigCode) that meet the requirements set forth by the document being signed. If signature module 235 cannot collect the required information, signature generation could be declined or allowed to continue with available or alternate information.

Once the signature has been generated, receipt module 240 can generate a signature receipt. The signature receipt can be displayed on a mobile device providing proof that the document has been signed. For example, if a waiver is required before an individual can purchase a ticket for participating in an activity (e.g., skiing). The signature receipt can be shown to the teller allowing the individual to purchase the ticket.

Verification module 245 can be used for retrieving information about the signed document, information about the signer, and other information for verifying the signature was from the signer. In some embodiments, a SigCode (or a portion thereof such as a QR code) and/or signature receipt can be submitted to verification module 245. Using this information, verification module 245 can retrieve the signed document and other information regarding the electronic signature for a storage system.

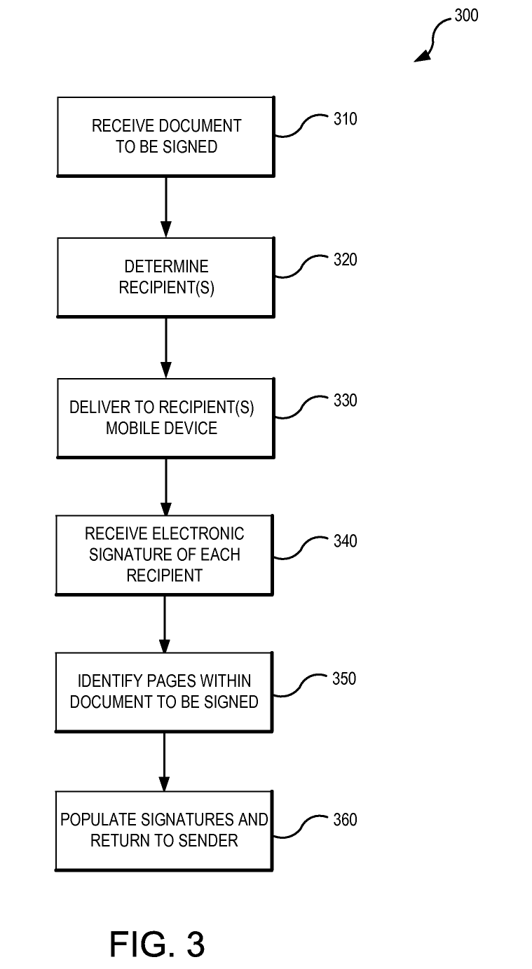

FIG. 3 is a flowchart showing a set of exemplary operations for obtaining electronic signatures from multiple recipients in accordance with some embodiments of the present invention. As illustrated in FIG. 3, a document to be signed can be received at receiving operation 310. The recipient(s) can be determined during determination operation 320 and the document can be delivered to the recipient(s) during delivery operation 330. The recipient(s) can review the document (e.g., via a certification system website) and generate an electronic signature (SigCode) which can then submitted to the certification system. Signature receiving operation 340 receives the electronic signature from each recipient. In some embodiments, receiving operation 340 may send out reminders to recipients if a signature is not received within a certain period of time (e.g., three days or one week).

Identifying operation 350 can use various techniques to identify pages within the document to be signed. For example, in some embodiments a character recognition system can be utilized. In other cases, the owner of the document may be requested to identify signature pages. Still yet, in other embodiments, the certification system can provide system defined signature pages to the owner of the document which the owner will include within the document.

Population operation 360 populates the signatures of the recipient and then returns the document to the sender. In some embodiments, information about the signatures is also stored in a database. This information can be easily retrieved by the owner of the document by submitting a code (e.g., a QR code) found within or associated with the signature. When submitted, information about the recipient and signature can be retrieved and displayed.

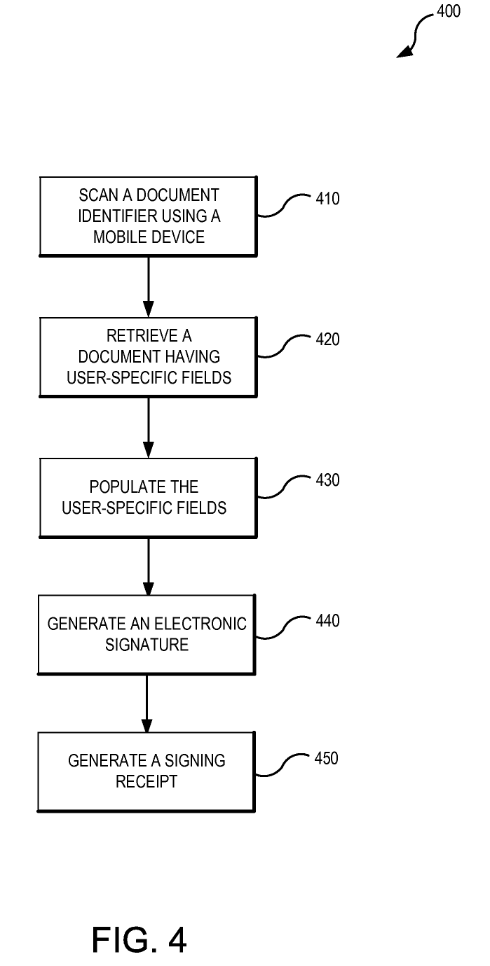

FIG. 4 is a flow chart illustrating an exemplary process 400 for electronically signing a document in accordance with various embodiments of the present invention. One or more of the operations in process 400 can be performed by field module 225, population module 230, signature module 235, and/or receipt 240. In the embodiments illustrated in FIG. 4, document identifiers (e.g., QR codes) can be used to identify and retrieve documents for digital signing during scanning operation 410. For example, a user can receive a non-electronic version of a document (e.g., such as a waiver form from a school) to be signed. The document can include a QR code or other document identifier which can be scanned by the user to retrieve an electronic version of the document from a server using retrieval operation 420. The electronic document can have one or more user-specific fields (e.g., name, title, address, telephone number, social security number, photo, driver's license number, account number, etc.) that need to be filled in by the user before signing.

In some embodiments, a population tool can be displayed on the user's mobile device that indicates the information required by the user-specific fields. In some cases, the population tool allows the user to select one or more profiles having stored therein a variety of information that can be used to fill in the user-specific fields. Once the information has been gathered, population operation 430 populates the user-specific fields within the electronic document. Then, the user can review the electronic document completed document and generated an electronic signature (SigCode) with the electronic signature tool with signature operation 440.

In some embodiments, the electronic signature can be embedded within the document. In other embodiments, the electronic signature can include a reference to a version of the document stored within a document database. In this case, whenever verification of the document is needed, certification system 150 pulls the version of the electronic document and then embeds the electronic signature. In some embodiments, receipt generation operation 450 generates a receipt indicating the document has been signed. The receipt, for example, can be immediately displayed on the user's mobile device to provide evidence of signing. In at least one embodiment, the receipt can be transmitted to a verification system, e-mail address, and/or other recipient.

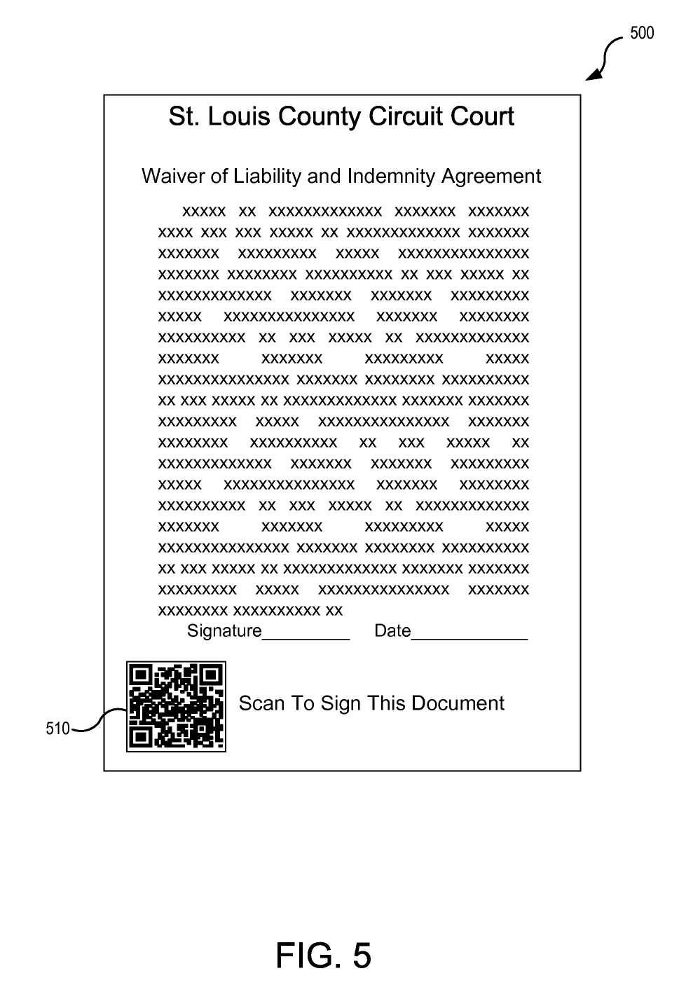

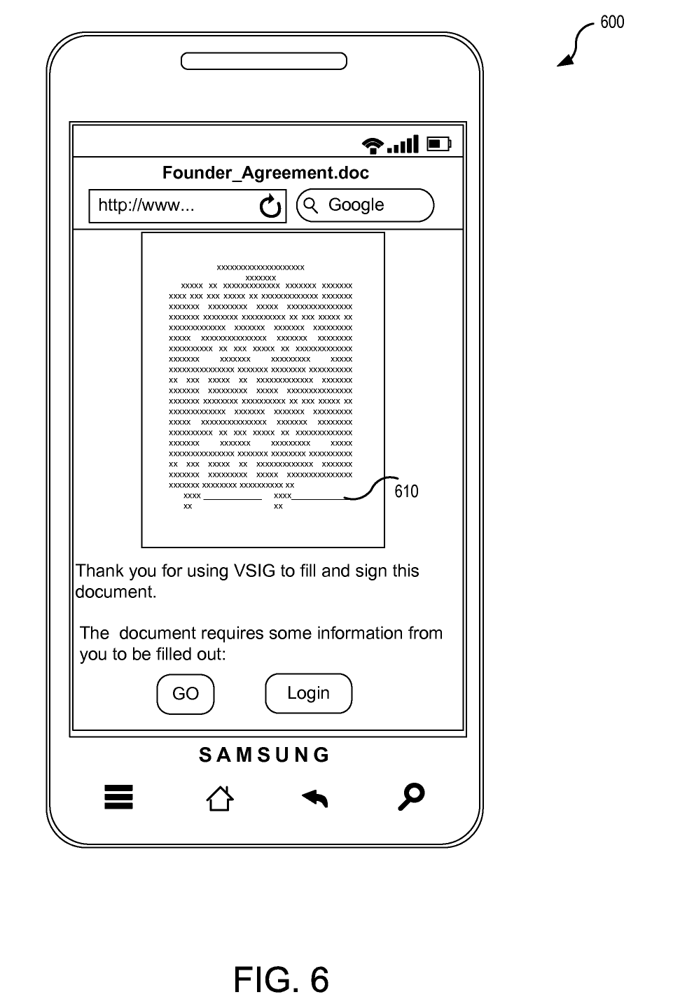

FIG. 5 shows an example of a document 500 with a document identifier 510 for electronically identifying and retrieving an electronic version of the document 500. The user can scan document identifier 510 with mobile device 600 shown in FIG. 6. An electronic version of document 500 having one or more user-specific fields 610 can be displayed on mobile device 600. The user can then decide to login and retrieve a user profile with some user-specific information or simply fill out the user specific fields manually.

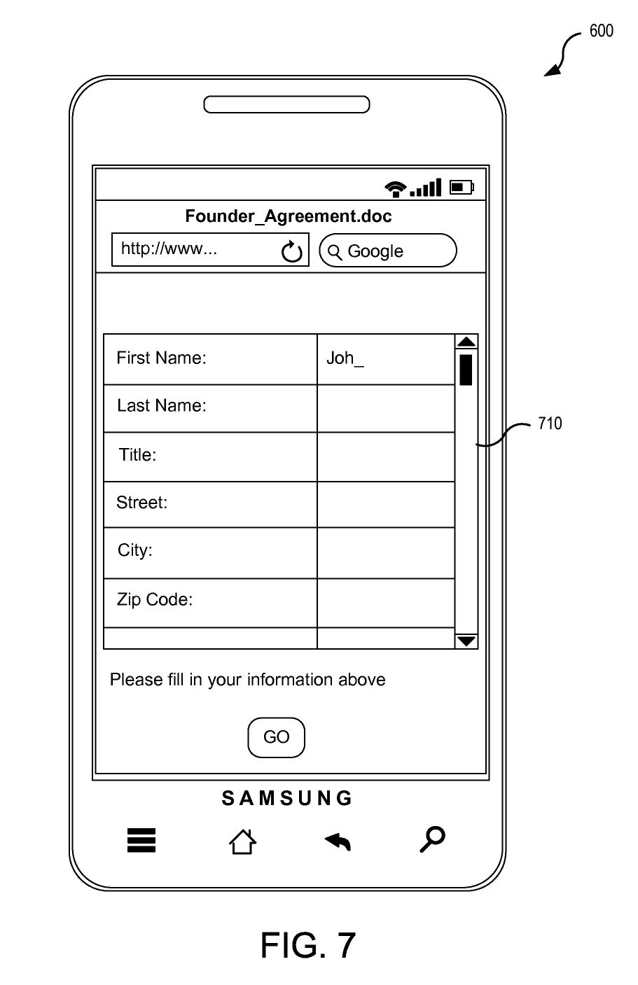

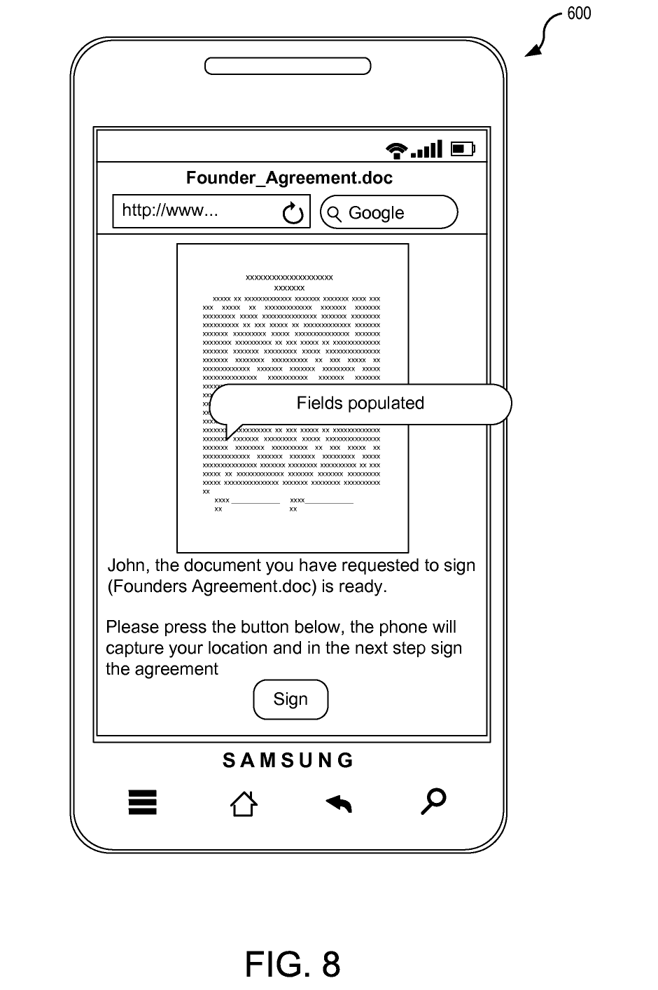

FIG. 7 illustrates mobile device 600 with a population tool 710 for populating the user-specific fields 610 within the electronic document. Each user-specified field identified when the document was submitted to the certification system shows up within population tool 710. Any user profile information can be automatically matched and filled in allowing for easy review by the user. Once the user indicates the information is correct, an electronic version of a document having one or more user specific fields populated can be displayed on the mobile device 600 as illustrated by FIG. 8.

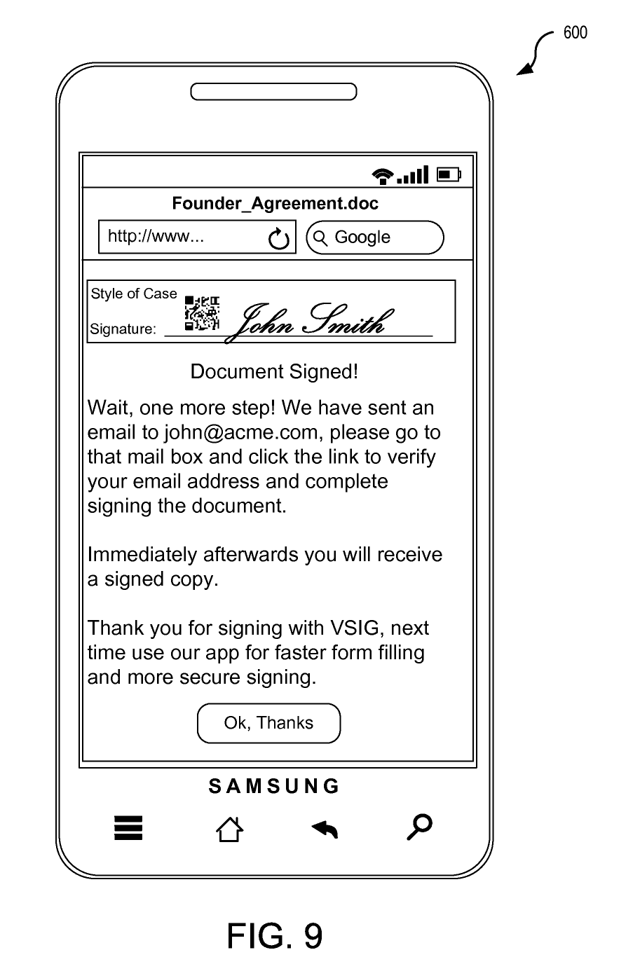

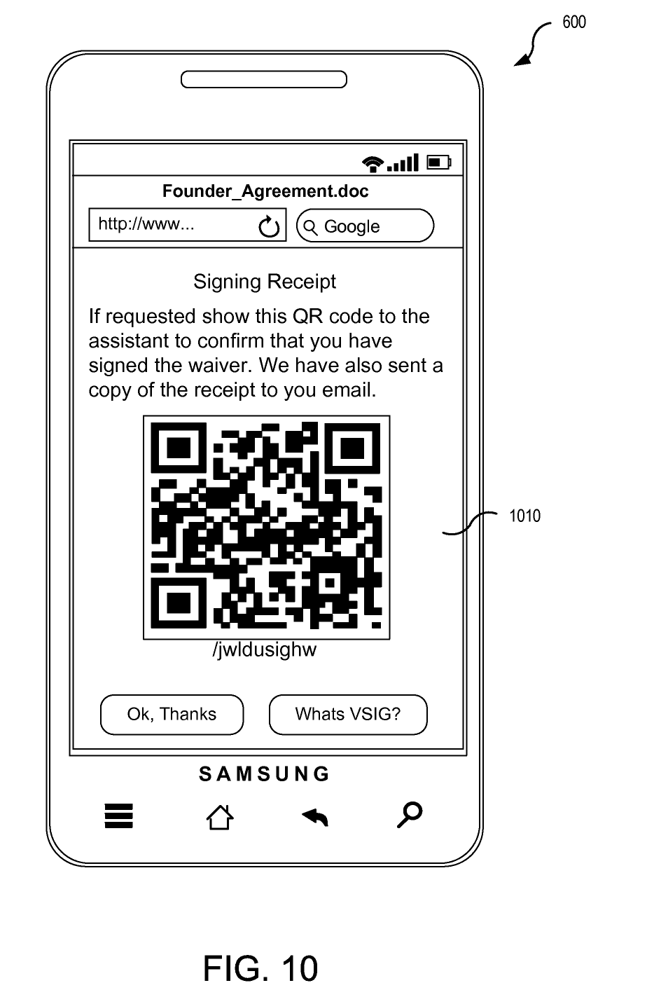

FIG. 9 shows an illustration of mobile device 600 displaying an electronic signature (SigCode) generated by the signature tool. In some embodiments, to complete the e-signing process, the user may be required to log-into an e-mail account and follow an activation link. In some embodiments, once the signing process is complete, signing receipt 1010 can be displayed on mobile device 600 as illustrated in FIG. 10. In some cases, signing receipt 1010 can be a QR code that allows for verification by a third party.

### Exemplary Computer System Overview

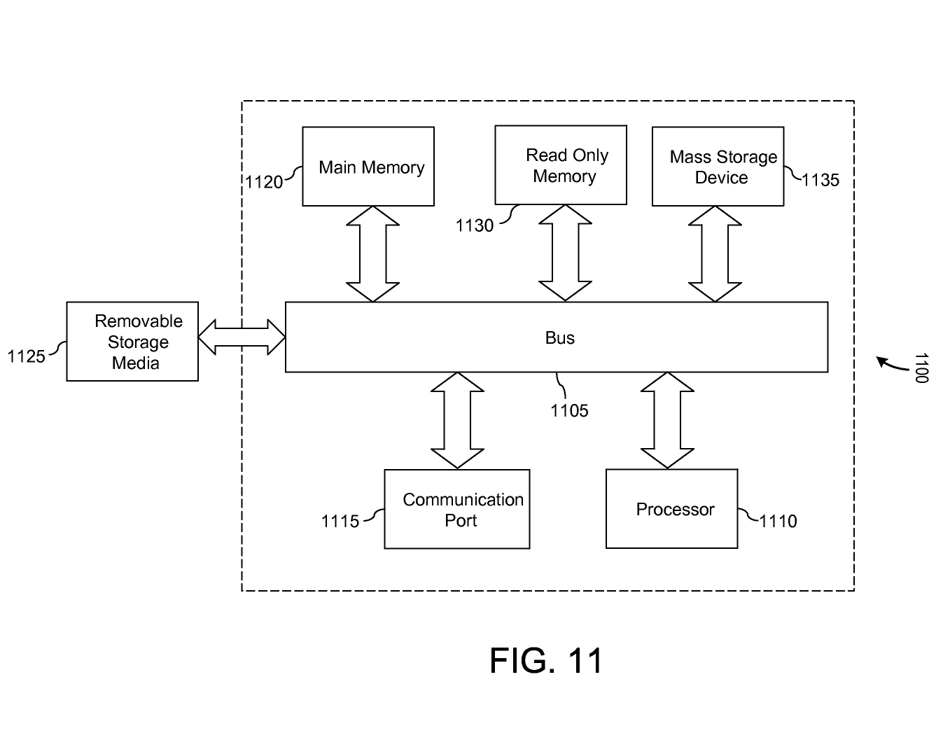

Embodiments of the present invention include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 11 is an example of a computer system 1100 with which embodiments of the present invention may be utilized. According to the present example, the computer system includes a bus 1105, at least one processor 1110, at least one communication port 1115, a main memory 1120, a removable storage media 1125, a read only memory 1130, and a mass storage 1135.

Processor(s) 1110 can be any known processor, such as, but not limited to, an Intel® Itanium® or Itanium 2® processor(s), or AMD® Opteron® or Athlon MP® processor(s), or Motorola® lines of processors. Communication port(s) 1115 can be any of an RS-232 port for use with a modem based dialup connection, a 10/100 Ethernet port, or a Gigabit port using copper or fiber. Communication port(s) 1115 may be chosen depending on a network such a Local Area Network (LAN), Wide Area Network (WAN), or any network to which the computer system 1100 connects.

Main memory 1120 can be Random Access Memory (RAM), or any other dynamic storage device(s) commonly known in the art. Read only memory 1130 can be any static storage device(s) such as Programmable Read Only Memory (PROM) chips for storing static information such as instructions for processor 1110.

Mass storage 1135 can be used to store information and instructions. For example, hard disks such as the Adaptec® family of SCSI drives, an optical disc, an array of disks such as RAID, such as the Adaptec family of RAID drives, or any other mass storage devices may be used.

Bus 1105 communicatively couples processor(s) 1110 with the other memory, storage and communication blocks. Bus 1105 can be a PCI/PCI-X or SCSI based system bus depending on the storage devices used.

Removable storage media 1125 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

The components described above are meant to exemplify some types of possibilities. In no way should the aforementioned examples limit the scope of the invention, as they are only exemplary embodiments.

In conclusion, the present invention provides novel systems, methods and arrangements for electronically signing documents. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof. Therefore, the above description should not be taken as limiting the scope of the invention, which is defined by the appended claims.

What is claimed is:

1. A method comprising:
receiving an electronic version of a document to be signed by a recipient;
delivering a notification requesting a signature for the document to a mobile device of the recipient;
receiving a SigCode from the mobile device, wherein the SigCode includes identifying information about the recipient;
identifying a signing page within the document; and
embedding the SigCode within the signing page of the electronic version of the document.

2. The method of claim 1, wherein the SigCode includes a quick response code.

3. The method of claim 2, wherein the identifying information includes geographic location information gathered at a time of creation of the SigCode and mobile carrier information.

4. The method of claim 2, wherein the identifying information includes a mobile device id and network address.

5. The method of claim 4, wherein the identifying information includes a time and date corresponding to creation of the SigCode.

6. The method of claim 2, further comprising embedding the quick response code on at least two pages of the document.

7. The method of claim 1, wherein the identifying information includes information to identify the electronic version of the document.

8. The method of claim 1, further comprising generating a receipt to verify signing of the electronic document.

9. A system comprising:
a document database having stored thereon a plurality of electronic documents;
a graphical user interface module to generate an interface screen for receiving a request to have one or more of the plurality of electronic documents signed by one or more recipients;
a communications module to send a communication to the one or more recipients regarding signing one or more of the plurality of electronic documents; and
a certification subsystem to receive a SigCode from each of the one or more recipients and to generate one or more signed documents by embedding the SigCode on a signature page of each signed electronic document.

10. The system of claim 9, further comprising a document capture device to create an electronic document to be stored in the document database.

11. The system of claim 9, wherein the document capture device embeds a document identifier within the electronic document.

12. The system of claim 9, wherein the SigCode includes geographic location information gathered at a time of creation of the SigCode, mobile carrier information, a mobile device identifier, a photo taken at the time creation of the SigCode, or a time stamp indicating a generation time of the SigCode.

13. The system of claim 9, further comprising a receipt module to generate a receipt providing verification that one or more of the plurality of electronic documents have been signed.

14. The system of claim 9, further comprising a verification module to verify the SigCode received from each of the one or more recipients.

15. A method comprising:
receiving, on a mobile device, a request from a document certification system to sign an electronic document;
submitting a document retrieval request to retrieve the electronic document from a document database; and
generating, at the mobile device, a SigCode for signing the electronic document, wherein the SigCode include identifying information about the electronic document.

16. The method of claim 15, further comprising submitting the SigCode to the document certification system to be embedded in the electronic document.

17. The method of claim 15, wherein the request to sign the document includes an expiration time.

18. The method of claim 15, wherein the document retrieval request includes an e-mail address associated with the mobile device.

19. The method of claim 15, wherein the SigCode includes geographic location information gathered at a time of creation of the SigCode and a mobile device identifier identifying the mobile device used to generate the SigCode.

20. The method of claim 15, further comprising receiving, from the document certification system, the electronic document with the SigCode embedded on a signing page of the electronic document.

21. A system comprising:
a communication means for generating a communication directed to one or more recipients regarding signing an electronic document and receiving a SigCode from each of the one or more recipients; and
a verification means for verifying each SigCode received from the one or more recipients; and
an embedding means for generating a signed document by embedding each SigCode on a signature page of the electronic document.

22. The system of claim 21, further comprising a means for receiving a signing request that includes the electronic document and identifies the one or more recipients.

23. The system of claim 21, further comprising a means for embedding a document identifier within the electronic document.

24. The system of claim 21, wherein the SigCode includes geographic location information gathered at a time of creation of the SigCode, mobile carrier information, a mobile device identifier, a photo taken at the time creation of the SigCode, or a time stamp indicating a generation time of the SigCode.

25. The system of claim 21, further comprising a means for generating each SigCode.

26. The system of claim 21, further comprising a means for identifying the signature page of the electronic document.
